(19) United States
(12) Patent Application Publication
(10) Pub. No.: US 2016/0267606 A1
(43) Pub. Date: Sep. 15, 2016

(54) SYSTEM AND METHOD FOR TRACKING PERSONNEL

(71) Applicants: Andrew Jay Shlesinger, Acton, MA (US); Frank Luther Bird, Andover, MA (US)

(72) Inventors: Andrew Jay Shlesinger, Acton, MA (US); Frank Luther Bird, Andover, MA (US)

(21) Appl. No.: 14/642,500

(22) Filed: Mar. 9, 2015

(51) Int. Cl. G06Q 40/00

(52) U.S. Cl. CPC G06Q 40/125

(57) ABSTRACT

A tracking system for ensuring the accountability of service providers including real-time reports and notifications to user/supervisors is provided. The tracking system may include a computer for a user to associate personnel with each predetermined location, wherein each personnel has an electronic key configured to provide an e-signature. The method includes the user setting up through a user interface of the computer a plurality of time marks at which time the personnel needs to provide the e-signature. Such time marks may include, but not be limited to, the start and end times for a predetermined shift, predetermined intervals of time of the predetermined shift, and time durations at which time a notification is sent to the user when the e-signature is not provided.

### BACKGROUND OF THE INVENTION

The present invention relates to personnel tracking and, more particularly, to a comprehensive system and method for ensuring the tracking of service providers including real-time reports and notifications to the users/supervisors.

In industries where services necessitate unsupervised yet alert and attentive staff including, but not limited to, overnight residential care of clients, there is a universal need to ensure the staff are awake, alert, and at their posts throughout their shifts to ensure clients are receiving the monitoring and care they require and staff are fulfilling their job requirements. Also, it is imperative that the staff's supervisors are informed immediately if at any point throughout the shift the staff member is unable to commence his/her duties for any reasons. While these are commonsense issues, especially in the residential care industries, no comprehensive solution exists to fill this need so critical to the health and safety of those entrusted in the care of overnight staff.

The paper signature option fails to ensure that the staff is awake, as they could sign all the intervals at any time. The call-in approach does not assure wakefulness throughout the night because if calls are missed, they are not discovered until the supervisor listens to the calls in the morning, when it is too late to remedy the lapse in health, safety, and monitoring that occurred the previous night. Neither solution provides a comprehensive, real-time report to the supervisor as the shift progresses, nor do they have a mechanism to alert supervisory staff immediately when an interval is late or unsigned.

As can be seen, there is a need for a comprehensive system and method for tracking service providers including real-time reports and notifications to supervisors.

### SUMMARY OF THE INVENTION

In one aspect of the present invention, a system for tracking personnel at predetermined locations comprises: an electronic key associated with each personnel; a computer having a user interface; a key transmitter for simultaneously sensing the electronic key and transmitting a corresponding e-signature to the computer; and a program product comprising machine-readable program code for causing, when executed, the computer to perform the following process steps: producing an electronic representation of the predetermined location comprising at least one associated personnel associated thereto; prompting a user via the user interface to set time marks, wherein time marks comprise a first time duration, a second time duration, a predetermined time interval, and a predetermined shift associated with the corresponding e-signature, wherein the predetermined shift comprises a start time and an end time; and transmitting a notification to the user when not receiving the e-signature within the second time duration from the most recent predetermined time interval.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a schematic diagram of an exemplary embodiment of the present invention;

FIG. 3 is a screen shot of an exemplary embodiment of the present invention;

FIG. 4 is a screen shot of an exemplary embodiment of the present invention; and

FIG. 5 is a screen shot of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a tracking system for ensuring the accountability of service providers including real-time reports and notifications to user/supervisors. The tracking system may include a computer for a user to associate personnel with each predetermined location, wherein each personnel has an electronic key configured to provide an e-signature. The method includes the user setting up through a user interface of the computer a plurality of time marks at which time the personnel needs to provide the e-signature. Such time marks may include, but not be limited to, the start and end times for a predetermined shift, predetermined intervals of time of the predetermined shift, and time durations at which time a notification is sent to the user when the e-signature is not provided.

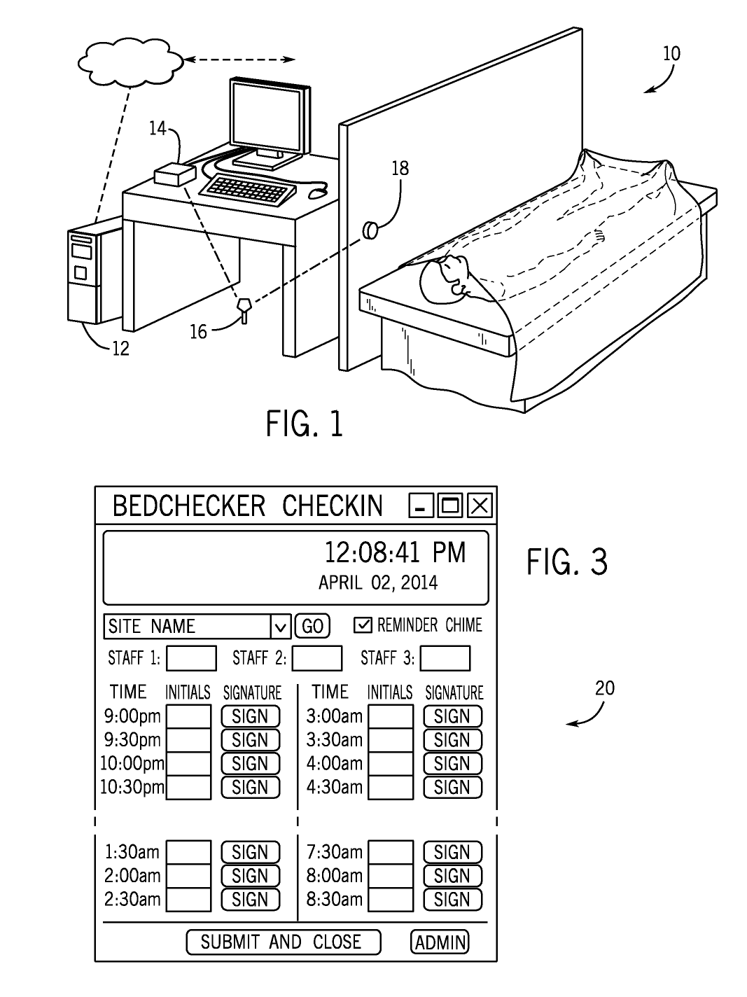

Referring to FIG. 1, the present invention may include a tracking system 10 embodying a method for ensuring the accountability of service providers including real-time reports and notifications to supervisors. The tracking system 10 may include at least one computer 12 with a user interface. Each computer 12 may include at least one processor electronically connected to a form of memory, including, but not limited to, a desktop, laptop, and smart device, such as, a tablet and smart phone. Each computer 12 includes a program product including a machine-readable program code for causing, when executed, the computer 12 to perform steps. The program product may include software which may either be loaded onto the computer 12 or accessed by the computer 12. The loaded software may include an application on a smart device. The software may be accessed by the computer using a web browser. The computer 12 may access the software via the web browser using the internet, extranet, intranet, host server, internet cloud and the like. The form of memory may include a storage database.

Each computer 12 may be located at predetermined locations 19 where a user provides services. The location 19 may be a commercial building that the user is responsible for security guarding with personnel, the location 19 may be a residence of a hospice patient that the user is responsible for monitoring with personnel, and the like. Each computer 12 may be electronically connected to a card reader 14. Each personnel and location 19 may be stored in the memory of each computer 12. The personnel may be selected by the user via the user interface so as to associate desired personnel with each predetermined location 19.

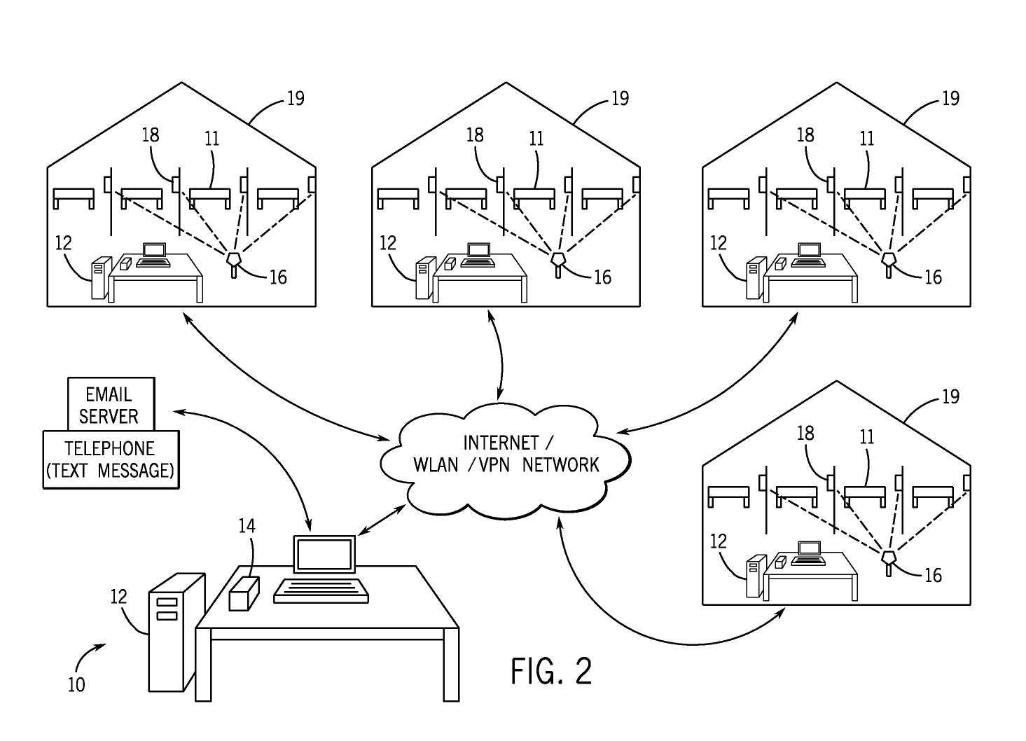

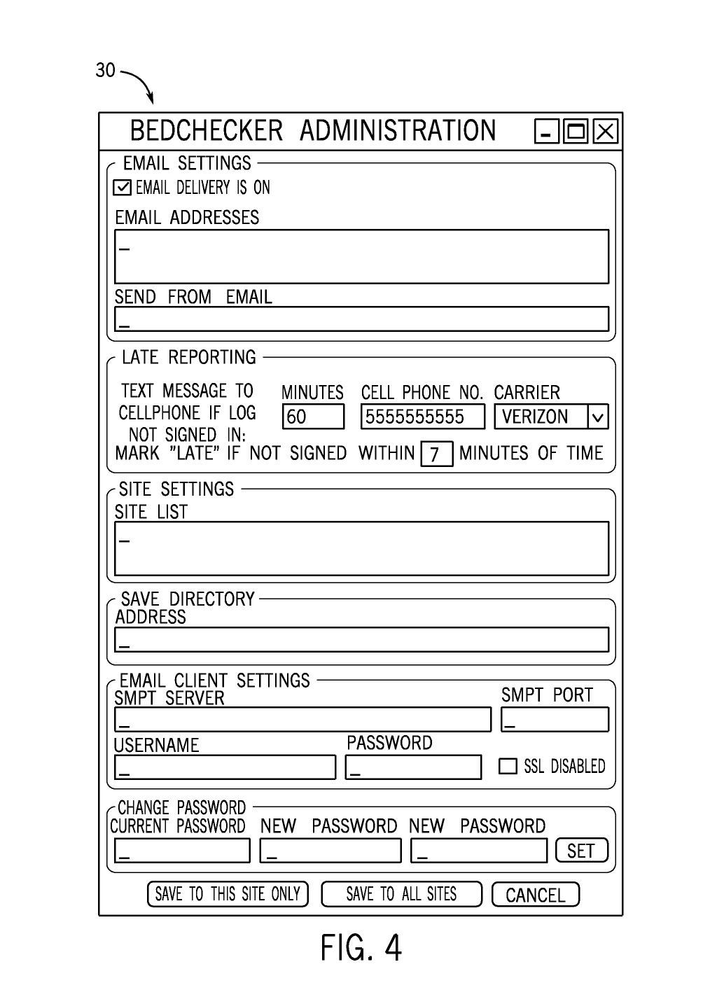

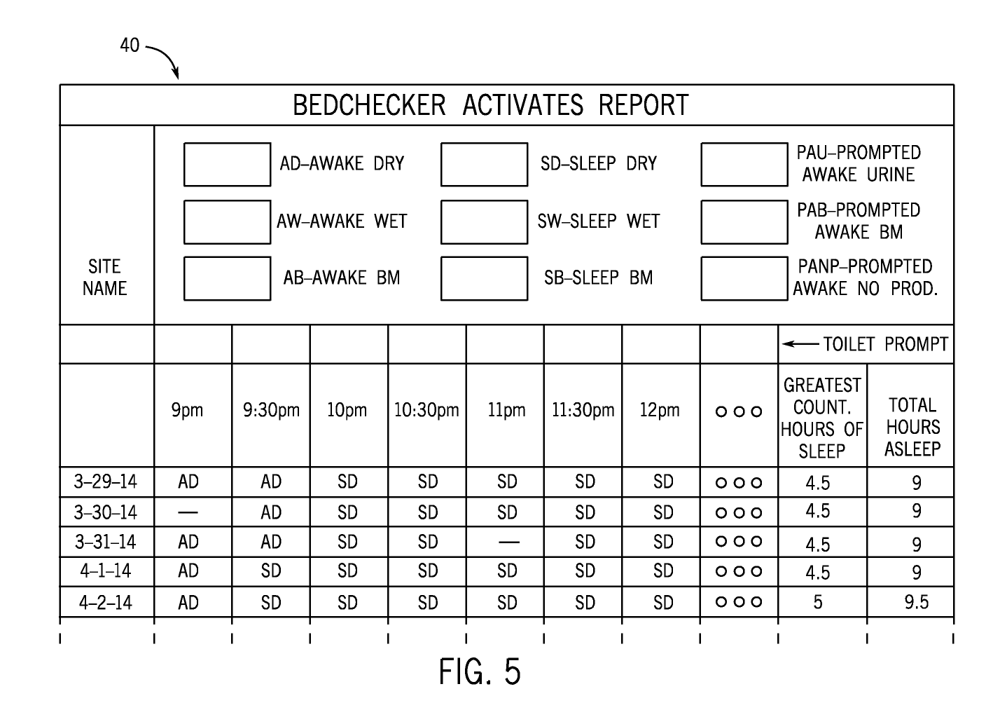

The tracking system 10 may also include a key transmitter 18, at least one personnel, each having an associated electronic key 16. The key transmitter 18 may be adapted to wirelessly communicate with each relevant computer 12 and/or card reader 14 whenever an associated electronic key 16 is sensed. The sensing of the associated electronic key 16 may include, but not be limited to, the electronic sensing of the electronic key adjacent to and/or nearby the key transmitter 18. As a result, a key transmitter 18 may be placed by specific areas within each location for verifying personnel's presence therein, by way of sensing their associated electronic key 16. For example, a key transmitter 18 may be placed by a bed 11 for each hospice patient of a residential location 19, as illustrated FIGS. 1 and 2.

The tracking system 10 may be adapted to collect and analyze verification data. Verification data may include, but not be limited to, time-stamped electronic signatures (e-signature) at predetermined time intervals (for example, every 15 minutes) for the entirety of a predetermined shift (for example, 9 pm to 9 am). The requirements for each e-signature may be defined by the user to include, but not be limited to textual notes, initials, a sensing of the electronic key 16 by the card reader 14 and/or the key transmitter 18, or the like.

The collection of verification data may be completed by user input via the computer 12. The computer 12 user interface may electronically produce a sign-in screen 20 to collect the verification data. The sign-in screen 20 may provide a text field for the user to enter their initials or a textual corresponding note for each time interval, as illustrated in FIG. 3. The sign-in screen 20 may also provide a submit button for predetermined personnel to press in order to send verification data currently captured in the sign-in screen 20. Each time the submit button is pressed corresponding to the predetermined time interval, the tracking system collects the verification data collected thus far, and prepares the real-time report to be saved to a predetermined location on the computer 12.

The tracking system 10 may be adapted to transmit the verification data electronically so as to be embodied in real-time reports and/or in a full-shift report 40. All reports may be delivered or exported via text message, email, or the like and saved to the computer 12.

Should the network server be unavailable due to unforeseen circumstances, the tracking system 10 will automatically save the real-time report to a local area on the computer 12 hard-drive until such time that network access is restored. In this way, a supervisor can access the real-time reports on the shared network location at any time of the relevant shift and get a real-time report of the progress up to and including the last entry by the personnel associate with each predetermined location.

Also, during the set-up procedure, the user may provide a first time duration and a second time duration. The first time duration may be a predetermined length of a first time interval wherein an electronic signature shall be considered timely and/or accounted for. The second time duration may a predetermined length of a second time interval, after which the tracking system 10 may consider the e-signature later and/or unaccounted for. The tracking system 10 may be adapted so that after the first time interval is surpassed, the tracking system 10 may transmit a first notification. The transmission of the first notification may be recorded into the real-time report. Should the predetermined personnel miss the second time interval, the tracking system 10 may be adapted to immediately transmit a second notification to the user/supervisor, and be recorded in the real-time report. Each notification may include an electronic transmission, such as an email or text message.

The tracking system 10 may be adapted so that at each predetermined time duration and each predetermined time interval, an audio and visual reminder chime is transmitted by each relevant computer 12.

After the shift, the user may electronically receive the full-shift report 40. The full-shift report 40 may include the summation of all real-time reports collected by the tracking system 10 within the predetermined shift.

A method of using the present invention may include the following. The tracking system 10 disclosed above may be provided. The computer 12 may electronically represent an administration screen 30 for a user to select at least one predetermined location 19 and at least one personnel to associated thereto. The administration screen 30 may prompt the user to provide identification information regarding the personnel.

The tracking system 10 may assign an electronic key 16 associated with said personnel for the collecting, analyzing and reporting of information as mentioned above.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for tracking personnel at predetermined locations, comprising:
an electronic key associated with each personnel;
a computer having a user interface;
a key transmitter for simultaneously sensing the electronic key and transmitting a corresponding e-signature to the computer; and
a program product comprising machine-readable program code for causing, when executed, the computer to perform the following process steps:
producing an electronic representation of the predetermined location comprising at least one associated personnel associated thereto;
prompting a user via the user interface to set time marks, wherein time marks comprise a first time duration, a second time duration, a predetermined time interval, and a predetermined shift associated with the corresponding e-signature, wherein the predetermined shift comprises a start time and an end time; and
transmitting a notification to the user when not receiving the e-signature within the second time duration from the most recent predetermined time interval.
